(19) United States
(12) Patent Application Publication
(10) Pub. No.: US 2006/0104636 A1
(43) Pub. Date: May 18, 2006

(54) Optical network for bi-directional wireless communication

(75) Inventors: Dae-Kwang Jung, Suwon-si (KR); Chang-Sup Shim, Seoul (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/281,761

(22) Filed: Nov. 17, 2005

(30) Foreign Application Priority Data
Nov. 17, 2004 (KR) 2004-93949

(51) Int. Cl. H04B 10/20

(52) U.S. Cl. 398/59

(57) ABSTRACT

A bi-directional metro-access optical network includes a central office for generating beams of different wavelength bands and a plurality of wavelength locked downward optical signals and for detecting wavelength locked upward optical signals; a plurality of nodes for detecting the downward optical signals of different wavelengths and for generating the wavelength locked upward optical signals of which wavelengths are locked by respective wavelength beams; a first optical fiber line for linking together each of the nodes with the central office in a ring shape, transmitting the upward optical signals to the central office, and transmitting the downward optical signals and the beams to each of the nodes; and a second optical fiber line for linking together each of the nodes with the central office in a ring shape along the circumference of the first optical fiber line.

### CLAIM OF PRIORITY

This application claims priority to an application entitled “BI-DIRECTIONAL METRO-ACCESS OPTICAL NETWORK,” filed in the Korean Intellectual Property Office on Nov. 17, 2004 and assigned Serial No. 2004-93949, the contents of which are hereby incorporated by reference.

### BACKGROUND OF THE INVENTION

1. Field of the Invention

The present invention relates to an optical communication network employing a wavelength division multiplexing scheme, and more particularly to an optical communication network having a self-healing ring structure.

2. Description of the Related Art

In recent years, as demands for various multimedia services based on Internet type media have increased, a PON (Passive Optical network) has been actively researched as the PON is capable of providing mass information at high speeds. The conventional PON generally includes a CO (Central Office) providing services, a plurality of subscribers receiving the services from the CO, and a plurality of RNs (Remote Nodes) linked to the CO via a single optical fiber and located adjacent to the subscribers. Therefore, the PON has a dual structure including both the CO and the plurality of RNs to provide the services to the subscribers.

In the conventional PON mentioned above, it is not possible for a central office (CO) to provide all the necessary services to a large number of subscribers. In order to solve this problem, the conventional PON located in a big city has generally a metro-access network structure including a local loop in which a plurality of RNs (Remote Nodes) are directly linked to the certain number of subscribers, and a network in which the central office is linked to each of the remote nodes connected with the subscribers.

FIGS. 1a and 1b illustrate the structure of a conventional metro-access optical network using a link protection switching solution. Referring to FIG. 1a through FIG. 1b, the conventional metro-access ring optical network includes a plurality of nodes that are linked with each other in a circular pattern via first and second optical fiber lines. Each of the nodes constituting a part of the ring optical network includes OADMs (Optical Add/Drop Multiplexer) 10a-40a and 10b-40b for dividing or coupling optical signals through the first and second optical fiber lines, and 2×2 switching apparatuses 110-180 for link protection switching, respectively.

In operation, the second optical fiber line 4 transmits optical signals of wavelengths λ₁ to λ_{N}, and the first optical fiber line 2 processes optical signals of wavelengths λ_{N+1} to λ_{2N}. The second optical fiber line 4 transmits the optical signals in a clockwise direction, and the first optical fiber line 2 transmits the optical signals in a counterclockwise direction.

When there is any trouble with a certain section in the first or second optical fiber lines, the metro-access optical network sends the optical signals of the troubled fiber line in a reversed direction using a protection switching. More specifically, a loop-back is made on the troubled optical fiber line using the two 2×2 switching apparatuses, each of which is located at the end points of the troubled fiber lines.

Referring to FIG. 1b, if there is an interruption occurred on the optical fiber line linked between an OADM1a 10a and an OADM2a 20a, optical signals λ₁ to λ_{N} generated from the OADM1a 10a to the OADM2a 20a are looped-back to an OADM1b 10b via a switching apparatus (sw12) 120 such that the optical signals λ₁ to λ_{N} are transmitted counterclockwise through the first optical fiber line 2. Then, the optical signals λ₁ to λ_{N} transmitted through the first optical fiber line 2 are transferred from an OADM2b 20b to an OADM2a 20a through a switching apparatus (21) 130.

When the conventional metro-access optical network operates normally, since the 2×2 optical switching apparatuses 110-180 are in parallel state (bar), a signal applied to an input1 i1 is transferred to an output1 o1, and a signal applied to an input2 i2 is transferred to an output2 o2. However, when an interruption occurs, the 2×2 optical switching apparatuses 110-180 are in a cross state, the signal applied to an input1 is transferred to an output2, and the signal applied to an input2 is transferred to an output1. Since the optical switching apparatus21 130 is in the cross state as shown in FIG. 1b, in addition to the signals passing through the interrupted link, optical signals λ_{N+1} to λ_{2N} transmitted counterclockwise from the OADM2b 20b to the OADM1b 10b are also looped-back and transmitted in the clockwise direction through the second optical fiber line 4. Thereafter, the optical signals λ_{N+1} to λ_{2N} are transferred from an OADM 1a 10a to an OADM1b 10b through a switching apparatus12 120. In the nodes that are not adjacent to the interrupted link, the remaining optical switching apparatuses thereof are kept in parallel state (bar) without any change.

In the conventional metro-access optical network of wavelength division multiplexing scheme, however, an expensive distributed feedback laser is required in order to produce optical signals having wavelengths that correspond with subscribers, respectively. Also, additional wavelength stabilizing apparatuses are further required for wavelength stabilization of the distributed feedback lasers in the conventional metro-access optical network. As a result, the economic burdens for employing expensive wavelength division multiplexing scheme are transferred to the subscribers in the conventional metro-access optical network.

### SUMMARY OF THE INVENTION

Accordingly, the present invention has been made to solve the above-mentioned problems occurring in the prior art and provides additional advantages, by providing a metro-access optical network with a wavelength division multiplexing scheme that can be realized in an inexpensive implementation.

In one embodiment, there is provided a bi-directional metro-access optical network, which includes a central office for generating beams of different wavelength bands and a plurality of wavelength locked downward optical signals and for detecting wavelength locked upward optical signals; a plurality of nodes for detecting the downward optical signals of different wavelengths and for generating the wavelength locked upward optical signals of which wavelengths are locked by corresponding different wavelength beams, respectively; a first optical fiber line for linking together each of the nodes with the central office in a ring shape, transmitting the upward optical signals to the central office, and transmitting the downward optical signals and the beams to each of the nodes; and a second optical fiber line for linking together each of the nodes with the central office in a ring shape along the circumference of the first optical fiber line.

### BRIEF DESCRIPTION OF THE DRAWINGS

The above features and advantages of the present invention will be more apparent from the following detailed description taken in conjunction with the accompanying drawings, in which:

FIGS. 1a and 2b illustrate a conventional a bi-directional optical network using a link protection switching scheme;

FIGS. 2a and 2b illustrate a structure of a bi-directional ring optical network, and a link protection switching scheme thereof according to one embodiment of the present invention; and

FIGS. 3 and 4 are graphical diagrams for showing the wavelength bands of uplink and downlink optical signals used in the ring optical network according to the embodiment of the present invention.

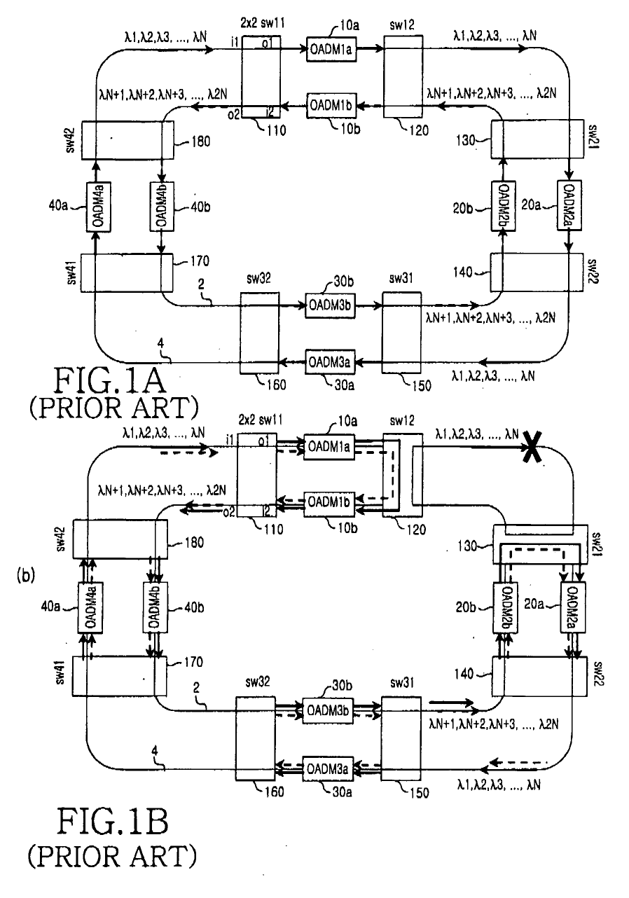

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

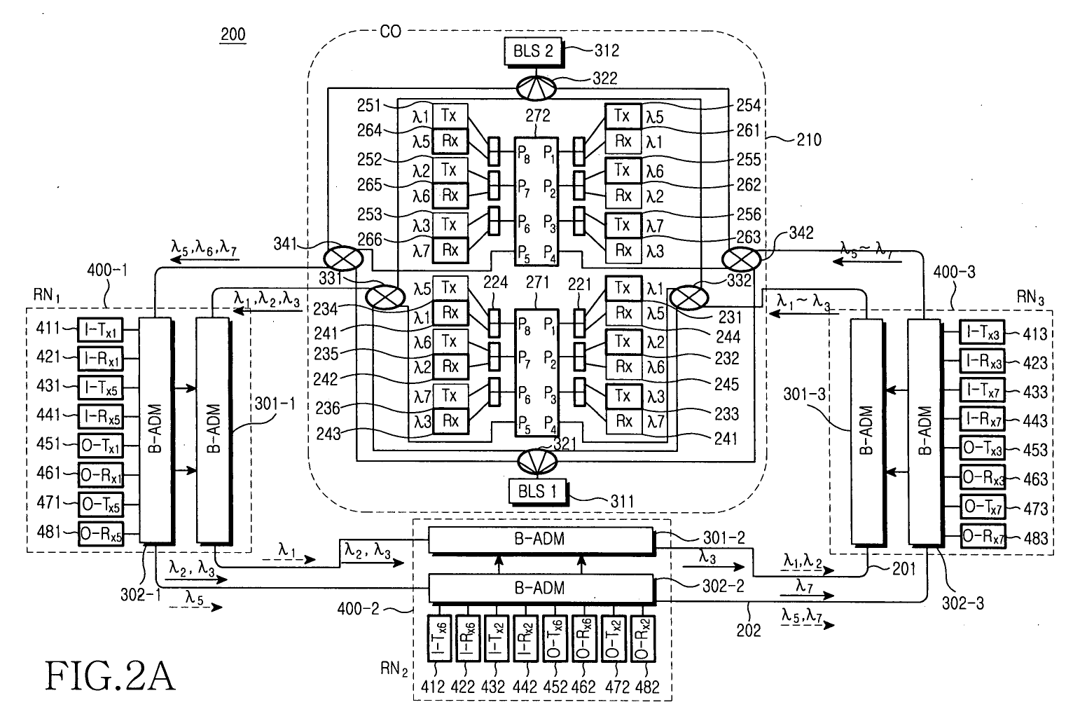

FIGS. 2a and 2b show a bi-directional metro-access optical network, and a link protection switching scheme according to one embodiment of the present invention. Referring to FIGS. 2a and 2b, the bi-directional metro-access optical network of a wavelength division multiplexing scheme according to the present invention includes a CO (Central Office) 210 for generating beams of different-wavelength bands and a plurality of wavelength locked downward optical signals and for detecting wavelength locked upward optical signals, a plurality of nodes 400-1 to 400-3 for detecting the downward optical signals of the corresponding wavelengths and for generating the wavelength locked upward optical signals of which wavelengths are locked by corresponding beams, respectively, and first and second optical fiber lines 201 and 202.

The central office 210 further includes first and second broadband light sources 311 and 312, a plurality of downward light sources 251 to 256 and 231 to 236 for generating the wavelength locked downward optical signals, a plurality of upward optical detectors 261 to 266 and 241 to 246 for detecting upward optical signals of which wavelengths correspond to the corresponding upward optical detectors, first and second multiplexer/demultiplexers 271 and 272, and first to fourth beam splitters 321, 322, 331, 332, 341 and 342.

The first broadband light source 311 generates first beams of relatively wider wavelength band, whereas the second broadband light source 312 generates second beams which are different from the first beams in wavelength band thereof.

Each of the downward light sources 251 to 256 and 231 to 236 generates wavelength locked downward optical signals, and the upward optical detectors 261 to 266 and 241 to 246 detects the upward optical signals of which wavelengths correspond to the respective upward optical detectors. Each of the downward light sources 251 to 256 and 231 to 236 and each of the upward optical detectors 261 to 266 and 241 to 246 are connected to a corresponding one of multiplexer/demultiplexers 271 and 272 through one of wavelength selection combiners 221 and 224, respectively.

The first multiplexer/demultiplexer 271 divides the first beams and the second beams into different-wavelength beams, output the divided beams to the corresponding downward light sources 231 to 236, respectively. Also, the first multiplexer/demultiplexer 271 multiplexes the downward optical signals of which wavelengths have been locked in the downward light sources 231 to 236, so that the multiplexed wavelength locked downward optical signals may be output to the first optical fiber line 201. Furthermore, the multiplexer/demultiplexer 271 receives the upward optical signals through the first optical fiber line 201 and demultiplexes the received upward optical signals to output the demultiplexed upward optical signals to the corresponding upward optical detectors 241 to 246.

The second multiplexer/demultiplexer 272 divides the first beams and the second beams into different-wavelength beams and outputs the divided beams to the corresponding downward light sources 251 to 256. Also, the second multiplexer/demultiplexer 272 multiplexes the downward optical signals of which wavelengths have been locked in the downward light sources 251 to 256, so that the multiplexed downward optical signals may be output to the second optical fiber lines 202. Furthermore, the multiplexer/demultiplexer 272 demultiplexes the upward optical signals to output the demultiplexed upward optical signals to the corresponding upward optical detectors 261 to 266.

Each of the first beam splitters 331 and 332 has first to forth ports. The first port is connected to the third beam splitter 321, the second port is connected to the first multiplexer/demultiplexer 271, and the third port is connected to the fourth beam splitter 322, respectively. The fourth port is connected between both ends of the first optical fiber line 201 to form a ring loop therewith. Accordingly, the first beam splitters 331 and 332 can transmit, to each of the nodes 400-1 to 400-3, the first and second beams, and the downward optical signals which have been multiplexed through the first optical fiber line 201. Also, the first beam splitters 331 and 332 output, to the first multiplexer/demultiplexer 271, the multiplexed upward optical signals which have been generated in the nodes 400-1 to 400-3 with wavelength thereof locked.

Similarly, each of the second beam splitters 341 and 342 has first to forth ports. The first port is connected to the fourth beam splitter 322, the second port is connected to the second multiplexer/demultiplexer 272, and the third port is connected to the third beam splitter 321, respectively. The fourth port is connected between both ends of the second optical fiber line 202 to form a ring loop therewith. Accordingly, the second beam splitters 341 and 342 can transmit, to each of the nodes 400-1 to 400-3, the first and the second beams, and the downward optical signals which have been multiplexed through the second optical fiber line 202. Also, the second beam splitters 341 and 342 output, to the second multiplexer/demultiplexer 272, the multiplexed upward optical signals which have been generated in the nodes 400-1 to 400-3 with wavelength thereof locked.

The third beam splitter 321 has first to fifth ports. The first port of the third beam splitter 321 is connected to the first broadband light source 311, the second to the fifth ports thereof are connected to the first and the second beam splitters 331, 332, 341 and 342, respectively. Accordingly, the third beam splitters 321 can receive the first beams through the first port, and output the received first beams to the first and second beam splitters 331, 332, 341 and 342 through the second to the fifth ports, respectively.

The fourth beam splitter 322 has first to fifth ports. The first port of the fourth beam splitter 322 is connected to the second broadband light source 312, and the second to the fifth ports thereof are connected to the first and second beam splitters 331, 332, 341 and 342, respectively. Accordingly, the fourth beam splitters 322 can receive the second beam through the first port, and output the received second beam to the first and second beam splitters 331, 332, 341 and 342 through the second to the fifth ports, respectively. The first optical fiber line 201 links each of the nodes 400-1 to 400-3 with the central office 210 in a ring shape.

Through the first optical fiber line are the upward optical signals transmitted to the central office 210, and the downward optical signals and the first beams or second beams transmitted to each of the nodes 400-1 to 400-3. Also, the second optical fiber line 202 links together each of the nodes 400-1 to 400-3 with the central office 210 in a ring shape around the circumference of the first optical fiber line 201. The second optical fiber line transmits beams of certain wavelength bands that are different from the wavelength bands of the downward and upward optical signals transmitted through the first optical fiber. The first and second optical fiber lines may be made of optical fibers.

The nodes 400-1 to 400-3 include first bi-directional multiplexer/demultiplexers 301-1 to 301-3 (for example, B-ADMs: Bi-directional Add/Drop Multiplexers) disposed on the first optical fiber line 201, second bi-directional multiplexer/demultiplexers 302-1 to 302-3 disposed on the second optical fiber line 202, a plurality of first upward light sources 411 to 413 and 431 to 433, a plurality of first downward optical detectors 421 to 423 and 441 to 443, a plurality of second upward light sources 451 to 453 and 471 to 473, and a plurality of second downward optical detectors 461 to 463 and 481 to 483.

The first bi-directional multiplexer/demultiplexers 301-1 to 301-3 are connected to the first upward light sources 411 to 413 and 431 to 433 and the first downward optical detectors 421 to 423 and 441 to 443. The second bi-directional multiplexer/demultiplexers 302-1 to 302-3 are connected with the second upward light sources 451 to 453 and 471 to 473 and the second downward optical detectors 461 to 463 and 481 to 483.

Referring to FIG. 2a, a normal operation of the metro-access optical network 200 according to the embodiment of the present invention will be described as follows.

The first broadband light source 311 generates first beams of a predetermined wavelength bands which are then output to the first multiplexer/demultiplexer 271 through the third beam splitter 321 and the corresponding first beam splitter 331, and output to the first optical fiber line through the second beam splitter 332. The first beams output to the first optical fiber line 201 turn around in the clockwise direction and are then input to corresponding nodes 400-1 to 400-3.

The first beams are input to the first multiplexer/demultiplexer 271 and divided individually based on the corresponding wavelengths of the beams so that the divided beams may be input to the corresponding downward light sources 231 to 236, respectively. The downward light sources 231 to 236 generate wavelength locked downward optical signals to output the generated signals to the first multiplexer/demultiplexer 271. The first multiplexer/demultiplexer 271 multiplexes the downward optical signals to transmit the multiplexed signals to the first optical fiber line 201 in the counterclockwise direction thereof through corresponding first beam splitter 331.

The first bi-directional multiplexer/demultiplexer 301-1 to 301-3 of the nodes 400-1 to 400-3 receive the multiplexed downward optical signals through the first optical fiber line 201 and demultiplex the received optical signals to output the downward optical signals of certain wavelengths to the first downward optical detectors 421 to 423 and 441 to 443 which correspond to the certain wavelengths and detect the corresponding downward optical signals, respectively.

Also, the first bi-directional multiplexer/demultiplexers 301-1 to 301-3 multiplex downward optical signals of other remained wavelengths that do not correspond to said certain wavelengths, then to transmit the signals of the remained wavelengths through the first optical fiber line 201 in the counterclockwise direction.

The first beams transmitted clockwise through the first optical fiber line 201 are divided into different wavelength beams individually based on each wavelength thereof in the first bi-directional multiplexer/demultiplexers 301-3 to 301-1, and are then input to corresponding first upward light sources 411 to 413 and 431 to 433. The first upward light sources 411 to 413 and 431 to 433 generate the wavelength locked upward optical signals, and the first bi-directional multiplexer/demultiplexer 301-1 to 301-3 multiplex the upward optical signals to transmit the multiplexed signals through the first optical fiber line 201 in the counterclockwise direction.

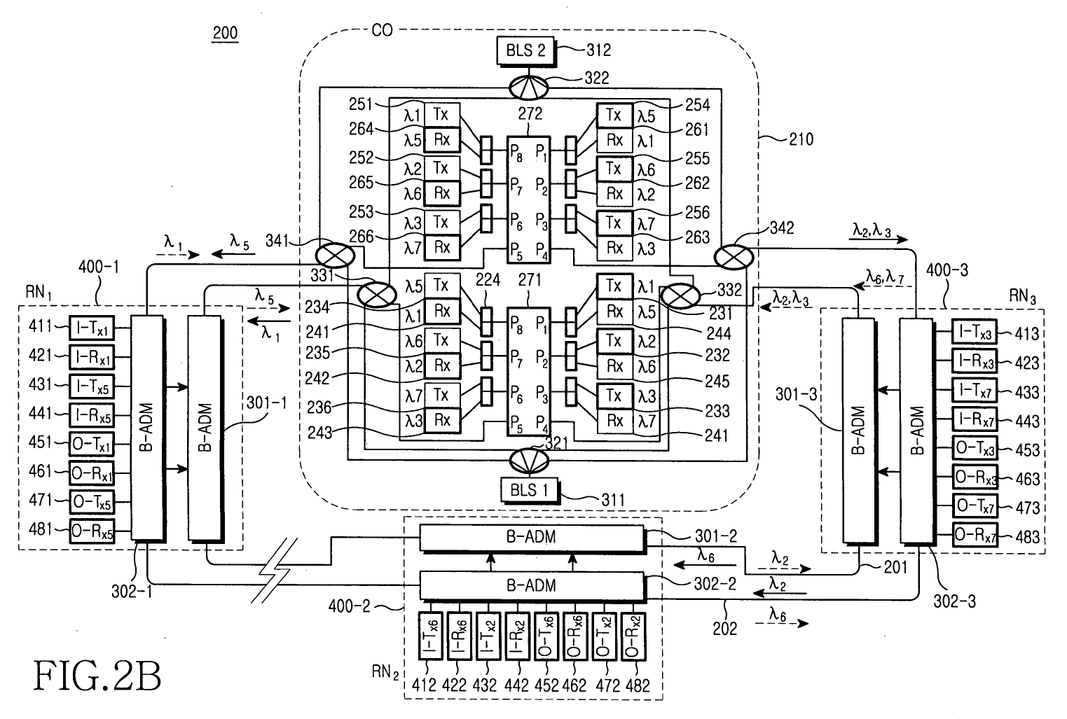

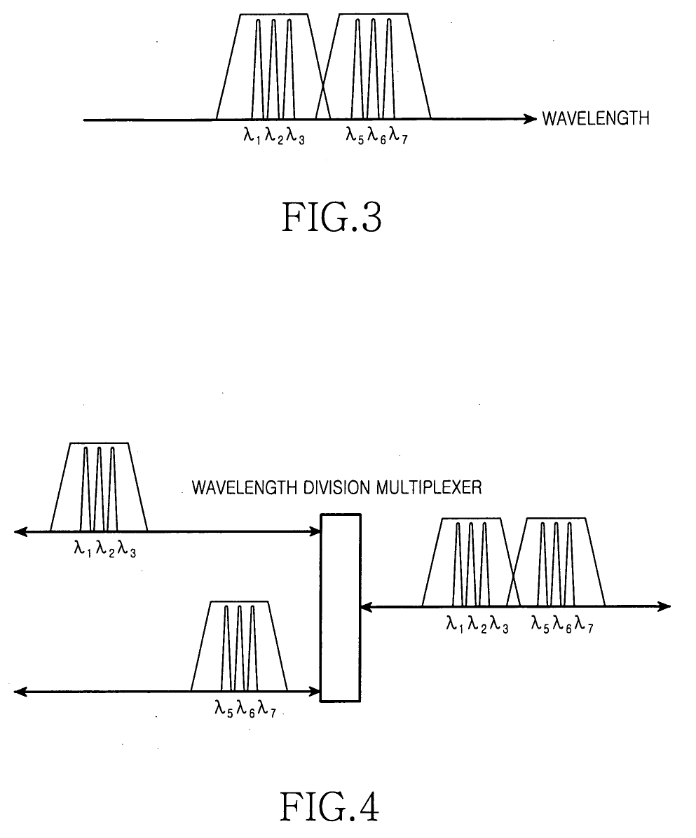

FIGS. 3 and 4 are diagrams showing the wavelength bands of the upward and downward optical signals used in the ring optical network of FIGS. 2a and 2b according to the embodiment of the present invention. The transmission operation of the second optical fiber line 202 is the same as that of the first optical fiber line 201, except that the second beams going through the second optical fiber line 202 and the wavelength bands λ₅ to λ₇ of the upward and downward optical signals are different from the first beams going through the first fiber line 201 and the wavelength bands λ₁ to λ₃ of the upward and downward optical signals.

More specifically, the upward and downward optical signals with the wavelengths thereof locked by the first beams are transmitted between the corresponding nodes 400-1 to 400-3 and the central office 210 through the first optical fiber line 201, whereas the upward and downward optical signals with wavelengths thereof locked by the second beams are transmitted between the corresponding nodes 400-1 to 400-3 and the central office 210 through the second optical fiber line 202.

The nodes 400-1 to 400-3 have the corresponding second bi-directional multiplexer/demultiplexers 302-1 to 302-3 disposed on the second optical fiber line 202, respectively. The second bi-directional multiplexer/demultiplexers 302-1 to 302-3 are connected to the second downward optical detectors 461 to 463 and 481 to 483 for detecting downward optical signals of the corresponding wavelengths, and connected to a plurality of upward light sources 451 to 453 and 471 to 473 for generating the wavelength locked upward optical signals of which wavelengths are locked by the corresponding divided second beams.

In more detail, the metro-access optical network 200 of the present invention in the normal operation thereof outputs the downward optical signals of wavelengths λ₁ to λ₃ from the central office 210 through the first optical fiber line 201 in the counterclockwise direction. Each of the downward optical signals is detected at corresponding one of the first to the third nodes 400-1 to 400-3 arranged counterclockwise and sequentially on the first optical fiber line 201 which starts at first from the central office 210. Specifically, the first node 400-1 detects a downward optical signal of wavelength λ₁, the second node 400-2 detects a downward optical signal of the wavelength λ₂, and the third node 400-3 detects a downward optical signal of the wavelength λ₃.

When the first beams are output in a clockwise direction from the central office 210, the third node 400-3 divides the first beams into beams of wavelengths λ₁ to λ₃ to output the beam of wavelength λ₃ to the corresponding first upward light source 413. The second node 400-2 divides the first beams into the beams of wavelengths λ₁ to λ₃ to output the beam of wavelength λ₂ to the corresponding first upward light source 432. The first node 400-1 divides the first beams into the beams of wavelengths λ₁ to λ₃ to output the beam of the wavelength λ₁ to corresponding first upward light source 411.

The first upward light sources corresponding to the first to the third nodes 400-1 to 400-3 generate the λ₁ to λ₃ wavelength locked upward optical signals λ₁ to λ₃, and output the wavelength locked upward optical signals λ₁ to λ₃ to the central office 210 through the corresponding first bi-directional multiplexer/demultiplexers 301-1 to 301-3 in the counterclockwise direction.

The transmission processes of the first beams for making a wavelength-locking of both the upward and downward optical signals and each of the nodes 400-1 to 400-3 in the first optical fiber line 201 are the same as those of the second beams in the second optical fiber line 202, except that the downward and upward optical signals transmitted through the second optical fiber line 202 use wavelengths band λ₅ to λ₇ which are different from those of the optical signals transmitted through first optical fiber line 201. In FIGS. 2a and 2b, dotted line arrows indicate progressing directions of the upward optical signals, and solid line arrows indicates progressing direction of the downward optical signals.

FIG. 2b illustrates a link protection switching method for making a preparation against emergency when an interruption occurs in the first or second optical fiber line of the metro-access optical network according to the embodiment of the present invention.

When there is an interruption occurred, the metro-access optical network of the present invention can determine a section where the interruption occurs, based on the half loss of the first and second beams and the upward and downward optical signals transmitted through the first and second optical fiber lines 201 and 202. Specifically, the central office 210 or the corresponding nodes 400-1 to 400-3 can determine the section of the interruption occurrence based on the power change in the optical signals detected in the upward or downward optical detectors.

If an interruption takes place, for example, in a section between the first and second nodes 400-1 and 400-2 on the first and second optical fiber lines 201 and 202, as shown in FIG. 2b, the first node 400-1 receives the downward optical signal λ₁ from central office 210 through the first optical fiber line 201, and the second downward optical detector 421 in the first node 400-1 detects the downward optical signal of λ₁ received through the second bi-directional multiplexer/demultiplexer 301-1 connected to the first optical fiber line 201.

Since the first node 400-1 can not send the λ₁ wavelength locked upward optical signal through the first optical fiber line 201 in the counterclockwise direction thereof, the first node 400-1 outputs, to the central office 210 through the second bi-directional multiplexer/demultiplexer 302-1, an upward optical signal of λ₁ which has been generated in the corresponding second upward light source 451 connected with the second optical fiber line.

The first beams are output from the central office 210 to the third and second nodes 400-3 and 400-2 through the first optical fiber line 201 in the clockwise direction thereof. The second node 400-2 outputs a λ₂ wavelength locked upward signal through the first optical fiber line 201 in the counterclockwise direction thereof. The third node 400-3 outputs a λ₃ wavelength locked upward signal through the first optical fiber line 201 in the counterclockwise direction. Downward optical signals of wavelengths λ₂ and λ₃ are output from the central office 210 through the second optical fiber line 202 in the clockwise direction. The second node 400-2 detects the downward optical signal of wavelength λ₂, and the third node 400-3 detects the downward optical signal of wavelength λ₃, respectively.

The second beams are output from the central office 210 to the third and second nodes 400-3 and 400-2 through the second optical fiber line 202 in the clockwise direction thereof. The second node 400-2 outputs a λ₆ wavelength locked upward optical signal through the first optical fiber line 201 in the counterclockwise direction thereof. The third node 400-3 outputs a λ₇ wavelength locked upward optical signal through the second optical fiber line 201 in the counterclockwise direction.

According to the present invention, a wavelength injection optical signal can be applied to the metro-access optical network such that the metro-access optical network can be constructed based on a wavelength division multiplexing method without implementing high cost optical amplifiers or diffraction gratings of waveguide type used in each node.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A bi-directional metro-access optical network, comprising:
a central office for generating beams of different wavelength bands and a plurality of wavelength locked downward optical signals and for detecting wavelength locked upward optical signals;
a plurality of nodes for detecting the downward optical signals of different wavelengths and for generating the wavelength locked upward optical signals of which wavelengths are locked by corresponding different wavelength beams, respectively;
a first optical fiber line for linking together each of the nodes with the central office in a ring shape, for transmitting the upward optical signals to the central office, and for transmitting the downward optical signals and the beams to each of the nodes; and
a second optical fiber line for linking together each of the nodes with the central office in a ring shape along the circumference of the first optical fiber line.

2. The optical network as claimed in claim 1, wherein the central office comprises:
a first broadband light source linked with the first optical fiber line and the second optical fiber line for generating first beams of wide wavelength band;
a second broadband light source linked with the first optical fiber line and the second optical fiber line for generating second beams of which wavelengths are different from those of the first beams;
a plurality of downward light sources for generating the wavelength locked downward optical signals;
a plurality of upward optical detectors for detecting the upward optical signals of the different wavelengths corresponding to the upward optical detectors, respectively;
a first multiplexer/demultiplexer for dividing the first beams and the second beams into different-wavelength beams to output the different-wavelength beams to corresponding downward light sources, respectively, for multiplexing the wavelength locked downward optical signals of which wavelengths have been locked in the corresponding downward light sources, respectively, to output the multiplexed wavelength locked downward optical signals to the first optical fiber line, and for demultiplexing the upward optical signals to output the demultiplexed upward optical signals to corresponding upward detectors; and
a second multiplexer/demultiplexer for dividing the first beams and the second beams into different-wavelength beams to output the different-wavelength beams to the corresponding downward light sources, respectively, for multiplexing the wavelength locked downward optical signals of which wavelengths have been locked in the corresponding downward light source, respectively, to output the multiplexed wavelength locked downward optical signals to the second optical fiber line, and for demultiplexing the upward optical signals to output the demultiplexed upward optical signals to corresponding upward detectors.

3. The optical network as claimed in claim 2, wherein the central office further comprises:
a pair of first beam splitters, each of which is disposed at both ends of the first optical fiber line and coupled with the first and second broadband light sources and the first multiplexer/demultiplexer, respectively;
a pair of second beam splitters, each of which is disposed at both ends of the second optical fiber line and coupled with the first and second broadband light sources and the second multiplexer/demultiplexer, respectively;
a third beam splitter including a plurality of ports which are coupled with the first beam splitters, the second beam splitters and the first broadband light source, the third beam splitter outputting the first beams to the first and second beam splitters; and
a fourth beam splitter including a plurality of ports that are coupled with the first beam splitters, the second beam splitters and the second broadband light source, respectively, the fourth beam splitter outputting the second beams to the corresponding second beam splitters.

4. The optical network as claimed in claim 2, wherein each of the first and second multiplexer/demultiplexers comprises diffraction grating of waveguide.

5. The optical network as claimed in claim 1, wherein the wavelength bands of the downward optical signals that the first optical fiber line transmits are different from the downward optical signals that the second fiber line transmits.

6. The optical network as claimed in claim 1, wherein the wavelength bands of the upward optical signals that the first optical fiber line transmits are different from the upward optical signals that the second fiber line transmits.

7. The optical network as claimed in claim 1, wherein each of the nodes comprises:
a first bi-directional multiplexer/demultiplexer disposed on the first optical fiber line, for dividing the first and second beams into different-wavelength beams to output the divided different-wavelength beams to corresponding upward light sources, respectively, and to output the downward optical signals of first certain wavelengths among all the downward optical signals to the downward optical detectors corresponding to said first certain wavelengths;
a second bi-directional multiplexer/demultiplexer disposed on the second optical fiber line, for dividing the second beams into different-wavelength beams to output the divided different-wavelength beams to corresponding upward light sources, respectively, and to output the downward optical signals of second certain wavelengths among all the downward optical signals to the downward optical detectors corresponding to the second certain wavelengths;
at least one first downward optical detector connected with the first bi-directional multiplexer/demultiplexer, for detecting downward optical signals the wavelengths which correspond to the first downward optical detectors, respectively;
at least one first upward light source coupled with the first bi-directional multiplexer/demultiplexer for generating wavelength locked upward optical signals;
at least one second downward optical detector coupled with the second bi-directional multiplexer/demultiplexer for detecting the upward optical signals of the wavelengths which correspond to the second downward optical detectors, respectively; and
at least one second upward light source coupled with the second bi-directional multiplexer/demultiplexer for generating wavelength locked upward optical signals.
